(19) United States
(12) Patent Application Publication
(10) Pub. No.: US 2026/0225459 A1
(43) Pub. Date: Aug. 6, 2026

(54) Control Method for Braking a Vehicle, Related Vehicle Braking System and Vehicle

(71) Applicant: Knorr-Bremse AG, Muenchen (DE)

(72) Inventors: Fernando VENEGAS DIAZ, Muenchen (DE); Aron KUTAS, Izsak (HU); Martin MEDERER, Neumarkt (DE); Krisztian SANDOR, Budapest (HU)

(21) Appl. No.: 19/042,080

(22) Filed: Jan. 31, 2025

(51) Int. Cl. B60L 7/26

(52) U.S. Cl. CPC B60L 7/26; B60L 2240/423

(57) ABSTRACT

A control method is disclosed for braking a vehicle having an electric powertrain with a generator configured to apply a torque to at least one wheel of a plurality of wheels of the vehicle. The vehicle further has a pressure operated braking system comprising friction brakes each comprising a respective brake chamber, wherein each friction brake is configured for braking the vehicle as a function of a braking pressure in the brake chamber of the respective friction brake, wherein each braking pressure is controlled by at least one valve and according to an open-loop control. The method includes receiving of a target value of a brake force by a controller; first braking of the vehicle according to a first braking configuration, second braking of the vehicle according to a second braking configuration; and a brake blending from the first braking configuration to the second braking configuration.

### BACKGROUND AND SUMMARY

The present disclosure relates to a control method for braking a vehicle comprising an electric powertrain. The disclosure furthermore relates to a vehicle braking system. The disclosure also relates a vehicle comprising an electric powertrain and a pressure operated braking system.

The present disclosure relates in particular to commercial vehicles.

Commercial vehicles generally comprise a pressure operated braking system, such as a pneumatic braking system, that is actuated according to braking pressure(s) in respective brake chambers. When the respective braking pressure is increased, an application of a friction brake is increased so as to brake the vehicle.

Pressure operated braking systems of many commercial vehicles operate according to an open-loop control. By “open-loop control”, it is understood in particular that the braking of the vehicle is operated without using measurement data of the braking pressure or independently of measurements of the braking pressure. Such a braking system is also called “ABS” for “Anti-lock Braking System”. ABS is, in comparison to braking systems called “EBS” (for “Electronic Braking System”), advantageous due to its simplicity.

While the open-loop control systems or ABS are simple and reliable, specific challenges remain. In general, during regular braking events, the braking pressure is proportional to the brake pedal application only and is uncontrolled. During stability braking events, such as an ABS event, open-loop pressure control is applied in such systems. This often requires a high number of pressure control valve actuations for adapting the brake force in an ABS event, still however without using measurements of the braking pressure. The frequent switching leads to a high wear of the valves and for example a frequent need of replacement.

Thus, an aim of the present disclosure is to provide a control method for braking a vehicle that prolongs the lifetime at least of some of the components of the vehicle, in particular of valves, while braking the vehicle in an easy, safe and reliable manner.

To this end, the present disclosure relates to a control method for braking a vehicle comprising an electric powertrain with a generator configured to apply a torque to at least one wheel of a plurality of wheels of the vehicle, wherein the vehicle further comprises a pressure operated braking system comprising friction brakes each comprising a respective brake chamber, wherein each friction brake is configured for braking the vehicle in function of a braking pressure in the brake chamber of the respective friction brake, wherein each braking pressure is controlled by at least one valve and according to an open-loop control.

The method comprises:
receiving of a target value of a brake force by a controller, the brake force being a force resulting from at least the torque applied by the generator and the braking pressure in said brake chamber;
first braking of the vehicle according to a first braking configuration, wherein in the first braking configuration, the braking pressure of at least one brake of said friction brakes is substantially equal to a first pressure value and the torque applied by the generator is equal to a first torque value,
second braking of the vehicle according to a second braking configuration, wherein in the second braking configuration, the braking pressure of said at least one brake is substantially equal to a second pressure value different from the first pressure value, and the torque applied by the generator is equal to a second torque value.

The method comprises a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.

The control method thus allows to reduce the wear on the valve(s) of the pressure operated braking system. In particular, the open loop-pressure control is applied for the case of brake blending according to the present disclosure. During the brake blending, the valve(s) is/are actuated a maximum number of times to change the braking pressure from the first pressure value to the second pressure value. Thus, the number of actuations of the valve(s) is reduced. At the same time, the target value of the brake force, for example received from a driver, is met thanks to the control of the torque applied by the generator.

According to the present disclosure, no measured pressure values of the braking pressure are used, as the modification of the braking pressure over time is estimated, for example according to known features or parameters of the pressure operated braking system. This allows using the simple type of open-loop braking system for a vehicle with an electric powertrain.

According to preferred embodiments, the present disclosure comprises one, several, or all of the following features, in all technically possible combinations:—during the brake blending, the torque applied by the generator is controlled so that, for each time step, a brake force applied to the vehicle resulting from both of said braking pressure and the torque applied by the generator is substantially equal to the target value of the brake force;
the maximum number of times is a predetermined number or the maximum number of times depends on predetermined time windows between each actuation of the at least one valve;
the maximum number of times is a predetermined number and equal to 2, consisting of one opening actuation and one closing actuation of said at least one valve;
the maximum number of times is a predetermined number and is equal to 1, consisting of one opening actuation or consisting of one closing actuation of said at least one valve;
the target value of the brake force is a constant value during the first braking, the brake blending and the second braking, wherein the brake force is substantially constant during the first braking, the brake blending and the second braking;
the target value of the brake force depends on a received signal from a driver or a foot brake module;
the first pressure value is substantially equal to an ambient pressure value;
the second pressure value is substantially equal to an ambient pressure value;
the target value of the brake force during the first braking is different from the target value of the brake force during the second braking;
the first torque value is different from the second torque value;
the first torque value is substantially equal to the second torque value;
the pressure modification estimation is obtained according to a predetermined model depending on at least on one of the following features: a volume of the brake chamber receiving a fluid having the braking pressure; a volume of piping connected to the brake chamber; a routing of piping connected to the brake chamber; a value of a fluid input pressure to said valve;
the valve presents a first switching state in which the braking pressure in the brake chamber increases or decreases according to a control pressure, wherein the valve presents a second switching state in which the braking pressure in the brake chamber is released, wherein the pressure modification estimation is obtained according to a predetermined model, wherein the predetermined model comprises a table defining, for a given duration of the valve in the first switching state or in the second switching state and a given control pressure, a value of the braking pressure;
the control method comprises a second brake blending implemented subsequently to the second braking and further comprises a third braking implemented subsequently to the second brake blending, wherein the target value of the brake force during the second braking is different from the target value of the brake force during the third braking, wherein the braking pressure during the second braking, the second brake blending and the third braking is substantially equal and strictly higher than an ambient pressure, wherein the torque applied by the generator during the third braking is different from the second torque;
the vehicle comprises at least a first axle and a second axle having respective friction brakes, wherein the braking pressure actuating the friction brakes of the first axle is, during the first braking, substantially equal to the first pressure value and during the second braking substantially equal to the second pressure value, wherein the braking pressure actuating the friction brakes of the second axle is substantially identical during the first braking and the second braking, wherein, during the brake blending, the torque applied by the generator is controlled so that, for each time step, a brake force applied to the vehicle resulting from all of the following is substantially equal to the target value of the brake force:
a braking caused by the braking pressure actuating the friction brakes of the first axle,
a braking caused by the braking pressure actuating the friction brakes of the second axle, and
a braking caused by the torque applied by the generator; the vehicle comprises at least a first axle and a second axle having respective friction brakes, wherein the braking pressure actuating the friction brakes of the first axle is, during the first braking, substantially equal to the first pressure value and during the second braking substantially equal to the second pressure value,
wherein the braking pressure actuating the friction brakes of the second axle is during the first braking substantially equal to the first pressure value and during the second braking substantially equal to the second pressure value,
wherein, during the brake blending, the torque applied by the generator is controlled so that, for each time step, a braking of the vehicle resulting from all of the following is substantially equal to the target value of the brake force:
a braking caused by the braking pressure actuating the friction brakes of the first axle,
a braking caused by the braking pressure actuating the friction brakes of the second axle, and
a braking caused by the torque applied by the generator;
the vehicle is a commercial vehicle.

The present disclosure furthermore relates to a vehicle braking system comprising a generator configured to apply a torque to at least one wheel of a plurality of wheels of the vehicle, wherein the vehicle braking system further comprises a pressure operated braking system comprising friction brakes each comprising a respective brake chamber, wherein each friction brake is configured for braking the vehicle in function of a braking pressure in the brake chamber of the respective friction brake, wherein each braking pressure is controlled by at least one valve and according to an open-loop control,
wherein the vehicle braking system comprises a controller configured to receive a target value of a brake force, the brake force being a force resulting at least from the torque applied by the generator and the braking pressure inside the brake chamber;
wherein the vehicle braking system is configured to brake the vehicle according to a first braking configuration, wherein in the first braking configuration, the braking pressure of at least one brake of said friction brakes is substantially equal to a first pressure value and the torque applied by the generator is equal to a first torque value,
wherein the vehicle braking system is configured to brake the vehicle according to a second braking configuration, wherein in the second braking configuration, the braking pressure of said at least one brake is substantially equal to a second pressure value different from the first pressure value, and the torque applied by the generator is equal to a second torque value,
wherein the vehicle braking system is configured to implement a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.

The present disclosure furthermore relates to a vehicle comprising an electric powertrain with a generator configured to apply a torque to at least one wheel of a plurality of wheels of the vehicle, wherein the vehicle further comprises a pressure operated braking system comprising friction brakes each comprising a respective brake chamber, wherein each friction brake is configured for braking the vehicle in function of a braking pressure in the brake chamber of the respective friction brake, wherein each braking pressure is controlled by at least one valve and according to an open-loop control,
wherein the vehicle comprises a controller configured to receive a target value of a brake force, the brake force being a force resulting at least from the torque applied by the generator and the braking pressure in said brake chamber;
wherein in a first braking configuration of the vehicle, the braking pressure of at least one brake of said friction brakes is substantially equal to a first pressure value and the torque applied by the generator is equal to a first torque value,
wherein in a second braking configuration of the vehicle, the braking pressure of said at least one brake is substantially equal to a second pressure value different from the first pressure value, and the torque applied by the generator is equal to a second torque value,
wherein the controller is configured to implement a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a part of a vehicle, such as a commercial vehicle, comprising a pressure operated braking system and an electric powertrain according to the present disclosure;

FIG. 2 shows graphs of a first example of a control method implemented by the vehicle of FIG. 1;

FIG. 3 shows graphs of a second example of a control method implemented by the vehicle of FIG. 1;

FIG. 4 shows graphs of a third example of a control method implemented by the vehicle of FIG. 1;

FIG. 5 shows graphs of a fourth example of a control method implemented by the vehicle of FIG. 1;

FIG. 6 shows graphs of a fifth example of a control method implemented by the vehicle of FIG. 1, and

FIG. 7 shows graphs of a sixth example of a control method implemented by the vehicle of FIG. 1.

### DETAILED DESCRIPTION OF THE DRAWINGS

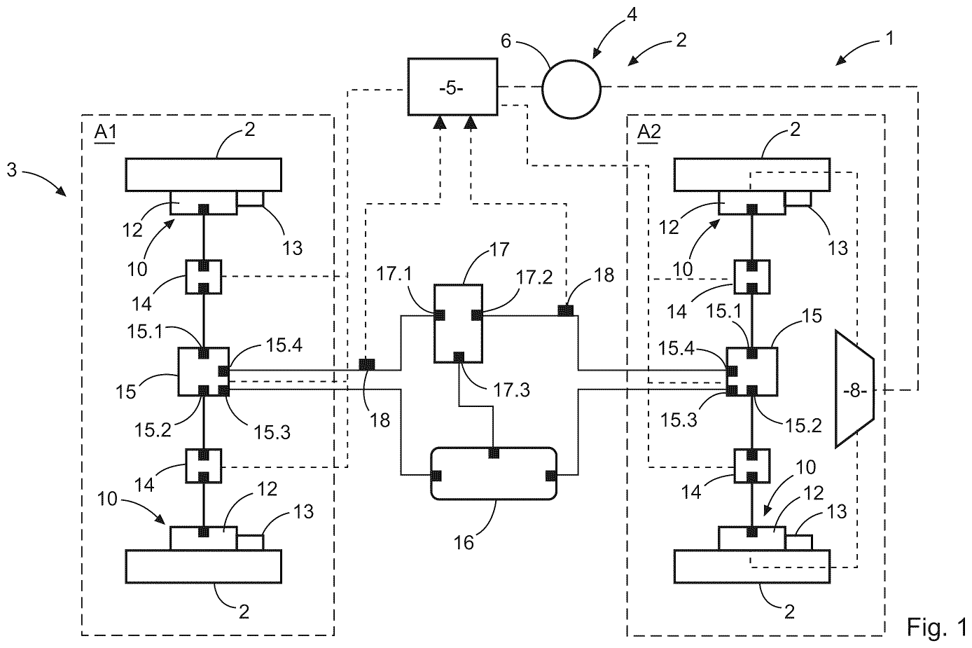

FIG. 1 shows a part of a vehicle 1, such as for example a commercial vehicle or truck or bus. The vehicle 1 comprises a plurality of axles A1, A2, such as a first axle A1 and a second axle A2. According to some examples, the vehicle 1 comprises more than two axles, for example three, four or five axles. Each axle A1, A2 comprises at least two wheels 2.

The vehicle 1 comprises a pressure operated braking system 3, an electric powertrain 4 and a controller 5 configured for receiving a target value of a brake force of the vehicle 1 and for controlling the pressure operated braking system 3 and the electric powertrain 4.

The vehicle 1 is in particular an electric vehicle using electrical energy for propulsion. According to some examples, the vehicle 1 is a hybrid vehicle using electrical energy for propulsion in some situations and in addition or alternatively a combustion motor for propulsion.

The electric powertrain 4 comprises at least one electric machine 6. The electric machine 6 is configured for propulsion of the wheels 2, wherein a corresponding torque for propulsion is transferred to the wheels 2 via a differential gearbox 8.

For braking of the vehicle 1, the electric machine 6 is operated as a generator. In this case, a corresponding torque is transferred from the wheels 2 to the electric machine 6. The electric machine 6, operating as a generator, transforms mechanical energy corresponding to the torque into electrical energy. Preferably, the electrical energy is stored or accumulated in an energy storage system of the vehicle 1, such as batteries. This allows retarding the vehicle 1. In the following, the electric machine 6 will be designated as generator in this case.

In the example of FIG. 1, the generator is configured to apply the torque to the second axle A2. According to other examples, the generator is configured to apply a torque only to one wheel 2 or to a plurality of wheels 2 of one or several axles A1, A2.

Referring still to the example of FIG. 1, as there is only one axle A2 propelled or braked by the electric machine 6, the braking effect caused by generator might be limited since the wheels 2 of axle A2 can only support a certain amount of brake force on the road. Further, if the electric energy generated by the generator during braking cannot be stored in an electric storage (not shown) since this storage is full, the pressure operated braking system 3 must be activated to brake the vehicle 1. Then, both the pressure operated braking system 3 and the generator apply a braking effect to the vehicle 1 in a blending operation. The blending operation will be described more in detail below.

According to examples, the pressure operated braking system 3, the controller 5 and the electric machine 6 operating as a generator form a vehicle braking system.

The pressure operated braking system 3 is configured for braking the vehicle 1. Referring to FIG. 1, the pressure operated braking system 3 comprises friction brakes 10 allocated to each wheel 2 and having in particular each a respective brake chamber 12. Each friction brake 10 is configured for braking the vehicle 1 in function of a braking pressure associated to the respective friction brake 10. The pressure designated as “braking pressure” is the pressure present in the respective brake chamber 12. Each friction brake 10 is for example a disc brake or a drum brake. Furthermore, a wheel speed detector 13 like a wheel speed sensor is allocated to each wheel 2 for detection of the respective wheel speed.

The pressure operated braking system 3 is for example configured as a pneumatic braking system. Therefore, a pressurized air reservoir 16 is provided to supply pressure to the braking system 3. According to not shown examples, the pressure operated braking system 3 comprises at least two air reservoirs. Preferentially, the at least two air reservoirs are separated fluidically from each other. For example, each air reservoir is configured for providing pressurized air independent from the other air reservoir.

The pressure operated braking system 3 comprises a brake demand source 17. The brake demand source 17 is for example a brake pedal or foot brake module adapted to be actuated by a driver. According to other examples, the brake demand source 17 is controlled by a controller (not shown) for autonomous or automated driving.

The brake demand source 17 is configured to supply a control pressure via its output ports 17.1, 17.2 to the axles A1, A2 according to a braking request of the driver if the brake demand source 17 is a brake pedal or foot brake module. Pressurized air from the air reservoir 16 is supplied to an input port 17.3 of the brake demand source 17.

At each axle A1, A2, a relay valve 15 is provided. The relay valve 15 comprises two output ports 15.1, 15.2 connected to respective actuators of the friction brakes 10 via a pressure control valve 14 (abbreviated PCV hereafter), respectively. Pressurized air from the air reservoir 16 is supplied to an input port 15.3 of the relay valve 15. Further, a control port 15.4 of the relay valve 15 of axle A1 is connected to the output port 17.1 of the brake demand source 17 and a control port 15.4 of the relay valve 15 of axle A2 is connected to the output port 17.2 of the brake demand source 17. The relay valve 15 is configured to generate the braking pressure which may be supplied from the output ports 15.1, 15.2 via the respective PCV 14 to the friction brakes 10, respectively. This braking pressure activates the actuators of the friction brakes 10 for braking the vehicle 1.

The braking pressure is controlled by the respective PCV(s) 14. In particular, each PCV 14 is configured to control the braking pressure supplied from the respective relay valve 15 to the friction brake 10. Therefore, each PCV 14 is configured to enable the connection between the relay valve 15 and the respective friction brake 10 according to a first switching state, to release the braking pressure according to a second switching state and to hold the braking pressure in the friction brakes 10 according to a third switching state. The first switching state is an open state of the PCV 14 in which the braking pressure in the respective brake chamber 12 increases according to the control pressure. The second switching state is a state in which the braking pressure is released from the brake chamber 12. According to examples, each PCV 14 is, when not being actuated or supplied with energy, in the first state. In particular, each PCV 14 is of the type “normally open”.

In the embodiment shown in FIG. 1, an activation pressure is generated by the relay valves 15 according to the control pressure of the brake demand source 17 which is supplied to the input ports 15.3 of the respective relay valves 15. In the first switching state of the respective PCV, the PCVs 14 establish the connection between the relay valves 15 and the friction brakes 10. In this state, the pressure operated braking system 3 brakes the vehicle 1.

The controller 5, also called ECU for “Electronic Control Unit”, comprises electronic control circuitry configured to control the pressure operated braking system 3 and the generator according to a received target value of the brake force. The controller 5 is further configured to control each PCV 14 and/or the relay valve(s) 15 according an open-loop control. By “open-loop control”, it is understood in particular that each braking of the vehicle 1 is controlled independently of measurement data of the braking pressure. This is also called a braking system of the type “ABS”, in comparison to “EBS” operating in closed-loop control. In particular, in the open loop control, the braking of the vehicle, and in particular the control of the valves 14 and/or 15, is operated without using measurement data of the braking pressure. In comparison, in closed-loop control, the braking pressure, i.e. the pressure in the brake chamber(s) 12, is measured and used for the control.

The pressure operated braking system 3 comprises preferably at least one, in the example of FIG. 1 two, pressure sensors 18 arranged to measure the control pressure provided by the brake demand source 17, i.e. for example the brake pedal or foot brake module. The or each pressure sensor 18 is for example arranged in the brake demand source 17, such as a foot brake module, or directly in an output line of the source 17. Each pressure sensor 18 may also be used for ESP purposes. Each pressure sensor 18 is configured to measure the output pressure of the source 17 only, corresponding to the driver demand, but not the executed pressure in the braking chamber(s) 12 of each friction brake 10.

The controller 5 is configured for receiving the measurement of the control pressure of each pressure sensor 18 corresponding in particular to the braking request by the driver. The controller 5 is configured to control the valves 14, 15 and the generator according to the request and in open loop.

The pressure operated braking system 3 is operated without feedback of pressure sensors measuring the braking pressure. The pressure operated braking system 3 is preferably deprived of pressure sensors arranged to measure the braking pressure inside the brake chamber(s) 12. The pressure operated braking system 3 is, according to a preferred aspect, an ABS-based braking system equipped with stability functions.

According to examples, the controller 5 is furthermore connected to the wheel speed detector 13, wherein wheel speed signals of the respective wheels 2 are provided to the controller 5. For better visibility, the electronic connections between the controller 5 and each wheel speed detector 13 are not shown FIG. 1.

### FIRST EXAMPLE OF THE CONTROL METHOD

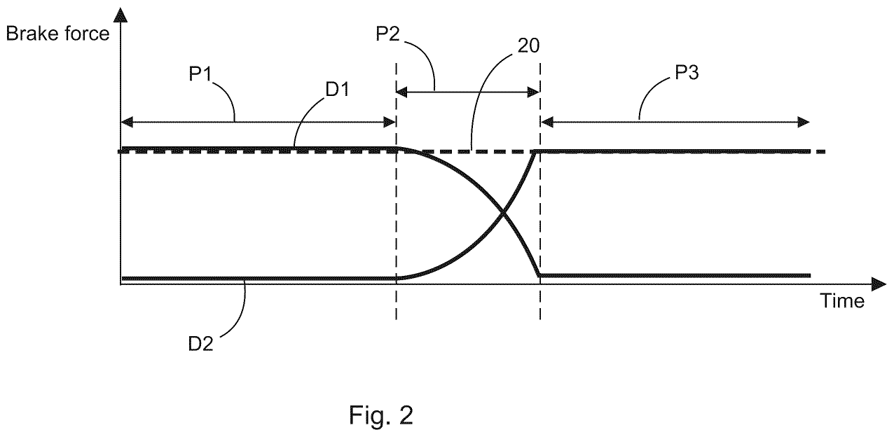

A first example of a control method for braking the vehicle 1 according to the present disclosure is now described with refence to FIG. 2.

FIG. 2 comprises graphs illustrating a brake force applied to the vehicle 1 over time according to the first example of the control method. The brake force results from the torque applied by the generator and the braking pressure associated to the respective friction brake(s). The brake force consists for example of the friction applied by the friction brake(s) and the torque applied by the generator. For a given brake force applied to the vehicle, the resulting deceleration depends for example on the mass of the vehicle 1.

In the present example, the brake force applied to the vehicle 1 results from the sum of a first braking value D1 resulting from a torque applied by the generator and a second braking value D2 resulting from the braking pressure associated to the friction brake(s) 10. The first braking value D1 depends, according to a predetermined function, on the torque applied by the generator. This predetermined function is for example a proportional function. The second braking value D2 depends, according to a predetermined function, on the braking pressure actuating the corresponding friction brake(s) 10.

The torque of the generator is in particular controlled so that, for each time step, an actual brake force applied to the vehicle 1 resulting from both of the braking pressure and the torque applied by the generator is substantially equal to the target value 20 of the brake force at each time step of the control method.

According to examples, the graphs of the FIG. 2 to 7 are not necessarily to scale. For example, the extend of the target value 20 on the axis of ordinates (y-axis) is not necessarily to be compared to the extend of the other graphs. According to examples, only the relative change of each graph is to be considered.

The control method comprises a receiving step, a first braking phase P1, a brake blending phase P2 and a second braking phase P3. The phases P1, P2 and P3 are in particular executed in this order.

During the receiving step, the controller 5 receives the target value 20 of the brake force of the vehicle 1. The target value 20 of the brake force depends in particular on a received signal depending on the brake demand source 17, i.e. in particular a foot brake module. In particular, the received signal is an electric signal of the pressure measurement of the pressure sensors 18 of the control pressure.

The target value 20 of the brake force is an objective of the braking of the vehicle 1. The target value 20 of the brake force corresponds in particular to a request of a driver, such as a human driver or an automated/machine driver. According to examples, the receiving step is repeated and is in particular implemented at each time step of the control method. For example, the controller 5 receives in real time the target value 20 of the brake force from the driver. According to examples, the target value 20 of the brake force is a constant value during the first braking phase P1, the brake blending phase P2 and the second braking phase P3. In this case, an actual brake force applied to the vehicle 1 is in particular substantially constant during the first braking phase P1, the brake blending phase P2 and the second braking phase P3.

According to the control method, the pressure operated braking system 3 and the generator are preferably controlled so that the actual brake force applied of the vehicle 1 is substantially equal to the target value 20 of the brake force at each time step. By “substantially equal to”, it is understood a value deviating from equality of values of less than +/−10%, preferably less than +/−5%, more preferably less than +/−2% and even more preferably less than +/−1%. In the case of the actual brake force being substantially equal to the target value 20, each for example expressed as a force in Newton (N) or a torque in Newton-meter (Nm). This means that these values deviate less than 10%, preferably less than 5%, more preferably less than 2% and even more preferably less than 1% from each other.

During the first braking phase P1, the vehicle 1 is braked according to a first braking configuration. In the first braking configuration, the braking pressure of at least one of the friction brakes 10, called active brake hereafter, is substantially equal to a first pressure value and the torque applied by the generator is equal to a first torque value. In the example of FIG. 2, the first pressure value is substantially equal to an ambient pressure value. The second braking value D2 is thus substantially equal to zero. The first braking value D1 resulting from the torque applied by the generator is substantially equal to the target value 20 of the brake force.

The brake blending phase P2 comprises a brake blending from the first braking configuration to a second braking configuration of the vehicle 1. The brake blending phase P2 is for example initiated if the generator alone is not able to provide a torque sufficient for meeting the target value 20 of the brake force and/or if, according to predefined rules, the generator alone shall not cover the whole braking effect of the vehicle 1, for example for stability reasons.

In the second braking configuration, the braking pressure of the or each active brake is in the second braking configuration substantially equal to a second pressure value different from the first pressure value. The torque applied by the generator is equal to a second torque value. In the example of FIG. 2, the second torque value is different to the first torque value. The second torque is preferably zero. The first braking value D1 is thus substantially zero and the second braking value D2 is substantially equal to the target value 20 of the brake force.

According to the present disclosure, the brake blending phase P2 comprises at least an actuating step, an estimating step and a controlling step.

During the actuating step, the controller 5 actuates the PCV 14 controlling the braking pressure of the active brake a maximum number of times to change the braking pressure from the first pressure value to the second pressure value. Limiting the actuation of the PCV(s) 14 to a maximum number reduces the wear of the PCV(s) 14. Thus, the braking pressure is built, upon actuation of the PCV(s) 14, in a natural or physical way, in particular according to characteristics of the physical shape of the pressure operated braking system 3. In particular, during the brake blending phase P2, the braking pressure is built or exhausted without active control of the PCV(s) 14 and/or the relay valve(s) 15. The valves 14 and/or 15 are controlled in open-loop.

According to examples, the maximum number of times is a predetermined number. By “predetermined number”, it is in particular understood a number that is fixed or determined in advance. For example, the predetermined number is 10, preferably 8, more preferably 5, even more preferably 3, even more preferably 2 and even more preferably 1. According to examples, the PCV 14 is actuated during the brake blending phase P2 the predetermined number of times.

According to examples, the maximum number of times depends on predetermined time windows between each actuation of the PCV 14. In particular, between each actuation of the PCV 14, a fixed or predetermined minimum time elapses. This results in a limitation of the number of actuations of the PCV 14 during the brake blending phase P2.

In the first example, in the beginning of the first braking phase P1, the controller 5 switches the PCV 14 from the first switching state, i.e. the valve being open, to the third switching state, i.e. the PCV 14 holding braking pressure equal to the ambient pressure value. In particular, the PCV 14 is energized.

As illustrated in FIG. 2, the controller 5 takes out the energy supply to the PCV 14 during the blending phase P2 and the PCV 14 switches from the third switching state to the first switching state. Thus, the PCV 14 opens so that the braking pressure increases according to the control pressure.

The predetermined number is for example equal to 2, consisting of one opening actuation and one closing actuation of the PCV 14.

According to a preferred example, the predetermined number is equal to 1, consisting of one opening actuation or one closing actuation of the PCV 14 of the active brake. In the example of FIG. 2, the actuation consists of one opening of the PCV 14 only. Thus, during the brake blending phase, the brake blending phase P2, the braking pressure increases according to a predetermined manner. The predetermined number is larger than zero.

During the estimating step, the controller 5 estimates a modification of the braking pressure of the active brake over time to obtain a pressure modification estimation. The controller 5 determines the pressure modification estimation in particular according to a predetermined function or model. According to examples, the model comprises a table defining, for a given duration of the PCV 14 in the first switching state or in the second switching state and a given control pressure, a value of the braking pressure. According to examples, the predetermined model depends on at least on one of the following features, preferably on all of the following features:
a volume of the brake chamber 12 receiving a fluid having the braking pressure;
a volume of piping connected to the brake chamber 12;
a routing of piping connected to the brake chamber 12;
a value of a fluid input pressure to the PCV 14.

Preferably, during the estimating step, the controller 5 estimates the second braking value D2 of the vehicle 1 resulting from the pressure modification estimation for each time step. According to other examples, the controller 5 estimates the second braking value D2 of the vehicle 1 during the controlling step.

During the controlling step, the controller 5 controls the torque applied by the generator from the first torque value to the second torque value in function of the pressure modification estimation and in function of the target value 20 of the brake force. In particular, the controller 5 controls the torque applied by the generator so that, for each time step, a brake force applied to the vehicle 1 resulting from both of the braking pressure and the torque applied by the generator is substantially equal to the target value 20 of the brake force. The controller 5 determines in particular the second braking value D2 based on the pressure modification estimation and determines the torque applied by the generator so that the sum of the determined second braking value D2 and the first braking value D1 according to the control of the generator is substantially equal to the target value 20 of the brake force.

The controlling step is implemented in particular during the entire duration of the brake blending phase P2.

### SECOND EXAMPLE OF THE CONTROL METHOD

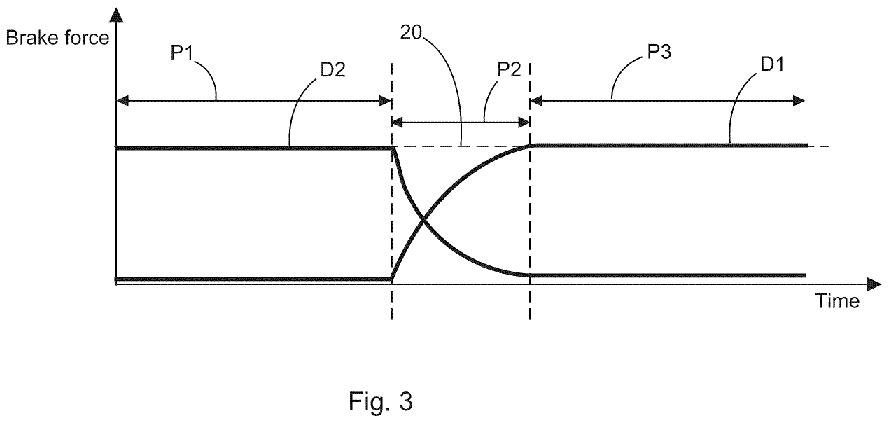

A second example of the control method for braking is described with reference to FIG. 3. The control method according to the second example comprises at least some, preferably all features of the first example, except the differences described hereafter.

During the first braking phase P1, the vehicle 1 is braked according to a first braking configuration. Contrary to the first example, in the second example, the first torque value is substantially equal to zero so that the first braking value D1 is substantially zero. The first pressure value has a value higher than the ambient pressure so that the second braking value D2 resulting from the pressure operated raking system 3 is substantially equal to the target value 20.

The brake blending phase P2 is for example initiated if predetermined rules indicate that the generator is capable of replacing, in a given driving situation of the vehicle 1 at least partially or fully the braking caused by the pressure operated braking system 3.

During the actuating step of the brake blending phase P2, the controller 5 switches the PCV 14 to the second switching state so that the braking pressure from the brake chamber 12 is released. Preferably, in the second example, the controller actuates the PCV 14 only once.

During the estimating step, the controller 5 estimates the decrease of the braking pressure of the active brake over time to obtain the pressure modification estimation, in particular according to the predetermined model.

During the controlling step, the controller 5 controls the torque applied by the generator from the first torque value, i.e. substantially zero in the second example, to the second torque value in function of the pressure modification estimation and in function of the target value 20 of the brake force. The controller 5 increases the torque applied by the generator so that at each time step, the sum of the first braking value D1 and the second braking value D2 is substantially equal to the target value 20 of the brake force.

During the second braking phase P3, the second pressure value is substantially equal to the ambient pressure value. The torque applied by the generator results substantially in the target value 20 of the brake force of the vehicle 1.

### THIRD EXAMPLE OF THE CONTROL METHOD

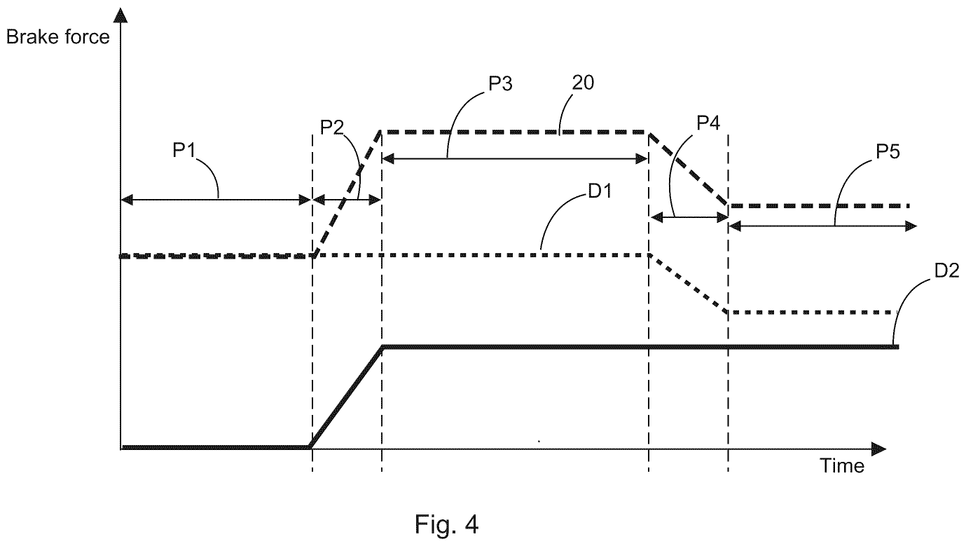

A third example of the control method for braking is described with reference to FIG. 4. The control method according to the third example comprises at least some, preferably all features of the first and/or the second example, except the differences described hereafter.

During the first braking phase P1, the first braking configuration is identical to the configuration of the first example.

During the brake blending phase P2, the target value 20 of the brake force increases. The torque applied by the generator remains constant. The controller 5 switches the PCV 14 to the first switching state so that the braking pressure increases according to the control pressure. The first switching state corresponds for example to an unenergized state of the PCV 14. After a determined time, the controller 5 switches the PCV 14 into the third switching state to hold the braking pressure.

For example, the controller 5 stops the increase of the braking pressure during the brake blending phase P2 at an intermediate point between the ambient pressure value and a value of the braking pressure according to which the target value 20 is met only by the pressure operated braking system 3. The latter is the control pressure. In particular, at the intermediate point, the generator generates a torque to meet the remainder of the required brake force to meet the target value 20. According to examples, subsequent adjustments of the target value 20 are met by modifying the torque applied by the generator only, without modifying the braking pressure.

During the second braking phase P3, the target value 20 of the brake force is different from the target value 20 during the first braking phase P1. In the example, the target value 20 of the brake force during the second braking phase P3 is higher than during the first braking phase P1. The first torque value, i.e. the torque applied by the generator during the first braking phase P1, is substantially equal to the second torque value, i.e. the torque applied by the generator during the second braking phase P3. The increased target value 20 of the brake force is met by the same torque applied by the generator as in the first braking phase P1, but with an increased braking pressure of the pressure operated braking system 3.

As illustrated in FIG. 4, the control method according to the third example comprises furthermore a second brake blending phase P4 implemented subsequently to the second braking phase P3 and a third braking phase P5 implemented subsequently to the second brake blending phase P4.

The target value 20 of the brake force during the second braking phase P3 is different from the target value 20 of the brake force during the third braking phase P5, for example higher. The braking pressure during the second braking phase P3, the second brake blending phase P4 and the third braking phase P5 is substantially equal and strictly higher than the ambient pressure. The torque applied by the generator during the third braking phase P5 is different from the second torque, i.e. the torque applied by the generator during the second braking phase P3. Thus, in particular, a decrease of the target value 20 of the brake force between the second braking phase P3 and the third braking phase P5 is met by decreasing the applied torque only, whereas the braking pressure remains constant.

### FOURTH EXAMPLE OF THE CONTROL METHOD

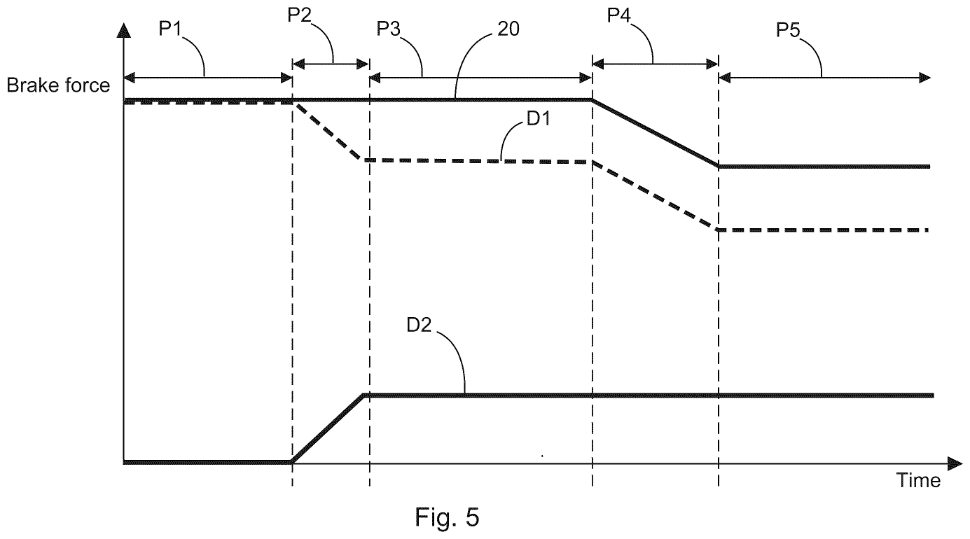

A fourth example of the control method for braking is described with reference to FIG. 5. The control method according to the fourth example comprises at least some, preferably all features of the first, the second and/or the third example, except the differences described hereafter.

During the first braking phase P1, the first braking configuration is identical to the configuration of the first example.

During the brake blending phase P2, the target value 20 of the brake force remains constant. The controller 5 switches the PCV 14 to the first switching state so that the braking pressure increases according to the control pressure and after a determined time switches the PCV 14 into the third switching state to hold the braking pressure. For example, the controller 5 stops the increase of the braking pressure during the brake blending phase P2 at an intermediate point between the ambient pressure value and a value of the braking pressure that applies the total target value 20 of the brake force to the vehicle 1 by the pressure operated braking system 3.

Furthermore, during the brake blending phase P2, the controller 5 decreases the torque applied by the generator so that, for each time step, the brake force resulting from both of the braking pressure, i.e. the second braking value D2, and the torque applied by the generator, i.e. the first braking value D1, is substantially equal to the target value 20 of the brake force.

The second brake blending phase P4 and the third braking phase P5 are identical in the third and fourth examples.

### FIFTH EXAMPLE OF THE CONTROL METHOD

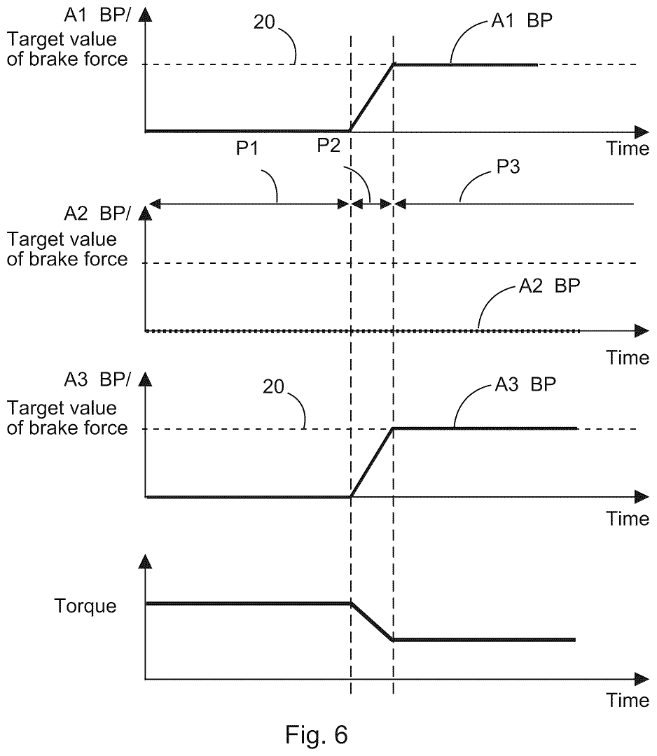

A fifth example of the control method for braking is described with reference to FIG. 6. The control method according to the fifth example comprises at least some, preferably all features of any of the first to fourth examples, except the differences described hereafter.

In the fifth example, the vehicle 1 comprises the first axle A1, for example a steer axle, the second axle A2, for example a driven rear axle, and a third axle A3, for example a non-driven rear axle.

FIG. 6 illustrates that the target value 20 of the brake force remains constant during the phases P1, P2 and P3. FIG. 6 furthermore comprises a graph of the braking pressure actuating the friction brakes of the first axle A1 over time, called “A1 BP”, a graph of the braking pressure actuating the friction brakes of the second axle A2 over time, called “A2 BP”, and furthermore a graph of the braking pressure actuating the friction brakes of the third axle A3 over time, called “A3 BP”. Each braking pressure is proportional to the brake force applied to the vehicle 1 by the friction brakes of the corresponding axle A1, A2, A3. FIG. 6 furthermore comprises a graph of the torque applied by the generator over time. The torque is proportional to the brake force applied by the generator to the vehicle 1, in form of a torque applied to at least one axle or wheel.

During the first braking phase P1, the braking pressure A1 BP is substantially equal to the first pressure value and during the second braking substantially equal to the second pressure value, which is different to the first pressure value. The same applies to the braking pressure A3 BP. The braking pressure A2 BP is substantially identical during the first braking phase P1 and the second braking phase P3, for example substantially equal to the ambient pressure.

During the brake blending phase P2, the torque applied by the generator is controlled so that, for each time step, a brake force applied to the vehicle 1 resulting from all of the following is substantially equal to the target value 20 of the brake force:
a braking caused by the braking pressure actuating the friction brakes of the first axle A1, i.e. braking pressure A1 BP,
a braking caused by the braking pressure actuating the friction brakes of the second axle A2,, i.e. braking pressure A2 BP,
if the vehicle 1 has a third axle A3, a braking caused by the braking pressure actuating the friction brakes of the third axle A3,, i.e. braking pressure A3 BP, and
a braking caused by the torque applied by the generator.

During the brake blending phase P2, the controller 5 actuates the PCV 14 of the first and/or the third axle A3 the maximum number of times as described above.

In particular, the braking pressure is built in selective axles only during the brake blending phase P2, while the controller 5 controls the torque applied by the generator to meet the target value 20 of the brake force.

### SIXTH EXAMPLE OF THE CONTROL METHOD

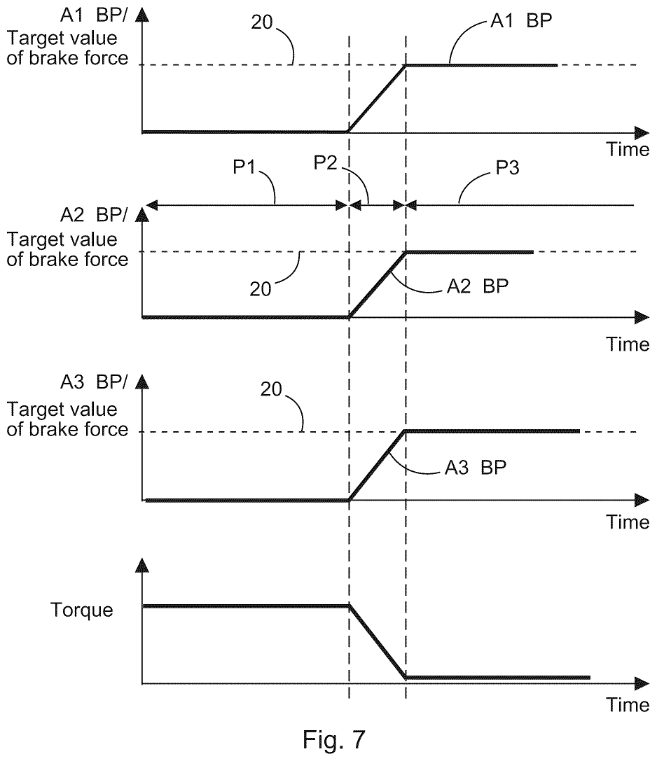

A sixth example of the control method for braking is described with reference to FIG. 7. The control method according to the fifth example comprises at least some, preferably all features of any of the first to fifth examples, except the differences described hereafter. In particular, the control method according to the sixth example comprises the features of the fifth example. The same reference signs are used.

Contrary to the fifth example, the braking pressure A2 BP during the first braking phase P1 is different from the braking pressure A2 BP during the second braking phase P3. In particular, during the first braking phase P1, the braking pressure A2 BP is equal to the first pressure value and during the second braking phase P2, the braking pressure A2 BP is equal to the second pressure value.

During the brake blending phase P2, the controller 5 actuates the corresponding PCV(s) 14 of each axle A1, A2 and A3 the maximum number of times, for example once, to change the braking pressure in all axles from the first pressure value to the second pressure value. The controller 5 controls the generator accordingly to meet the target value 20 of the brake force at each time step of the brake blending phase P2. Preferably, during the second braking phase P3, the torque applied by the generator is substantially zero.

### FURTHER EXAMPLES OF THE CONTROL METHOD

Further examples of the control method comprise possible combinations of any of the first to sixth examples. For example, the control method comprises the phases P1, P2 and P3 of the fifth or sixth example, followed by the phases P4 and P5. In this case, adjustments of the target value 20 of the brake force in phases P4 and P5 are met by variations of the applied torque only, while the braking pressure in each of the axles A1, A2 and possibly A3 of the vehicle 1 remains constant.

Further combinations of the examples are possible and comprised in the scope of the disclosure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

1 vehicle
A1 axle
A2 axle
A3 axle
2 wheel
3 pressure operated braking system
4 electric powertrain
5 controller
6 electric machine
8 differential gearbox
10 friction brake
12 brake chamber
13 wheel speed detector
14 pressure control valve (PCV)
15 relay valve
15.1 output port
15.2 output port
15.3 input port
15.4 control port
16 pressurized air reservoir
16.1 first reservoir
16.2 second reservoir
17 brake demand source
17.1 output port
17.2 output port
17.3 input port
17.4 input port
20 target value of brake force
P1 first braking phase
P2 blending phase
P3 second braking phase
P4 second brake blending phase
P5 third braking phase
D1 first braking value
D2 second braking value
A1 BP braking pressure of axle A1
A2 BP braking pressure of axle A2
A3 BP braking pressure of axle A3

What is claimed is:

1. A control method for braking a vehicle comprising an electric powertrain with a generator configured to apply a torque to at least one wheel of a plurality of wheels of the vehicle,
wherein the vehicle further comprises a pressure operated braking system comprising friction brakes each comprising a respective brake chamber, wherein each friction brake is configured for braking the vehicle as a function of a braking pressure in the brake chamber of the respective friction brake, wherein each braking pressure is controlled by at least one valve and according to an open-loop control,
wherein the method comprises:
receiving a target value of a brake force by a controller, the brake force being a force resulting from at least the torque applied by the generator and the braking pressure in said brake chamber;
first braking of the vehicle according to a first braking configuration, wherein in the first braking configuration, the braking pressure of at least one brake of said friction brakes is substantially equal to a first pressure value and the torque applied by the generator is equal to a first torque value;
second braking of the vehicle according to a second braking configuration, wherein in the second braking configuration, the braking pressure of said at least one brake is substantially equal to a second pressure value different from the first pressure value, and the torque applied by the generator is equal to a second torque value;
wherein the method further comprises a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.

2. The control method according to claim 1, wherein,
during the brake blending, the torque applied by the generator is controlled so that, for each time step, a brake force applied to the vehicle resulting from both of said braking pressure and the torque applied by the generator is substantially equal to the target value of the brake force.

3. The control method according to claim 1, wherein
the maximum number of times is a predetermined number or the maximum number of times depends on predetermined time windows between each actuation of the at least one valve.

4. The control method according to claim 1, wherein
the maximum number of times is a predetermined number and equal to 2, including one opening actuation and one closing actuation of said at least one valve.

5. The control method according to claim 1, wherein
the maximum number of times is a predetermined number and is equal to 1, including of one opening actuation or one closing actuation of said at least one valve.

6. The control method according to claim 1, wherein
the target value of the brake force is a constant value during the first braking, the brake blending and the second braking, wherein the brake force is substantially constant during the first braking, the brake blending and the second braking.

7. The control method according to claim 1, wherein the target value of the brake force depends on a received signal from a driver or a foot brake module.

8. The control method according to claim 1, wherein
the first pressure value is substantially equal to an ambient pressure value or the second pressure value is substantially equal to an ambient pressure value.

9. The control method according to claim 1, wherein
the target value of the brake force during the first braking is different from the target value of the brake force during the second braking.

10. The control method according to claim 1, wherein the first torque value is different from the second torque value.

11. The control method according to claim 1, wherein the first torque value is substantially equal to the second torque value.

12. The control method according to claim 1, wherein the pressure modification estimation is obtained according to a predetermined model depending on at least on one of the following:
a volume of the brake chamber receiving a fluid having the braking pressure;
a volume of piping connected to the brake chamber;
a routing of piping connected to the brake chamber; or
a value of a fluid input pressure to said valve.

13. The control method according to claim 1, wherein
the valve presents a first switching state in which the braking pressure in the brake chamber increases or decreases according to a control pressure, wherein the valve presents a second switching state in which the braking pressure in the brake chamber is released, and
the pressure modification estimation is obtained according to a predetermined model, wherein the predetermined model comprises a table defining, for a given duration of the valve in the first switching state or in the second switching state and a given control pressure, a value of the braking pressure.

14. The control method according to claim 1, wherein
the control method comprises a second brake blending implemented subsequently to the second braking and further comprises a third braking implemented subsequently to the second brake blending,
the target value of the brake force during the second braking is different from the target value of the brake force during the third braking,
the braking pressure during the second braking, the second brake blending and the third braking is substantially equal and strictly higher than an ambient pressure,
the torque applied by the generator during the third braking is different from the second torque.

15. The control method according to claim 1, wherein the vehicle comprises at least a first axle and a second axle having respective friction brakes, wherein the braking pressure actuating the friction brakes of the first axle is, during the first braking, substantially equal to the first pressure value and during the second braking substantially equal to the second pressure value,
wherein the braking pressure actuating the friction brakes of the second axle is substantially identical during the first braking and the second braking,
wherein, during the brake blending, the torque applied by the generator is controlled so that, for each time step, a brake force applied to the vehicle resulting from all of the following is substantially equal to the target value of the brake force:
a braking caused by the braking pressure actuating the friction brakes of the first axle,
a braking caused by the braking pressure actuating the friction brakes of the second axle, and
a braking caused by the torque applied by the generator.

16. The control method according to claim 1, wherein the vehicle comprises at least a first axle and a second axle having respective friction brakes, wherein the braking pressure actuating the friction brakes of the first axle is, during the first braking, substantially equal to the first pressure value and during the second braking substantially equal to the second pressure value,
wherein the braking pressure actuating the friction brakes of the second axle is during the first braking substantially equal to the first pressure value and during the second braking substantially equal to the second pressure value,
wherein, during the brake blending, the torque applied by the generator is controlled so that, for each time step, a braking of the vehicle resulting from all of the following is substantially equal to the target value of the brake force:
a braking caused by the braking pressure actuating the friction brakes of the first axle,
a braking caused by the braking pressure actuating the friction brakes of the second axle, and
a braking caused by the torque applied by the generator.

17. The control method according to claim 1, wherein the vehicle is a commercial vehicle.

18. A vehicle braking system, comprising:
a generator configured to apply a torque to at least one wheel of a plurality of wheels of the vehicle;
a pressure operated braking system comprising friction brakes each comprising a respective brake chamber, wherein each friction brake is configured for braking the vehicle as a function of a braking pressure in the brake chamber of the respective friction brake, wherein each braking pressure is controlled by at least one valve and according to an open-loop control; and
a controller configured to receive a target value of a brake force, the brake force being a force resulting at least from the torque applied by the generator and the braking pressure inside the brake chamber;
wherein the vehicle braking system is configured to brake the vehicle according to a first braking configuration, wherein in the first braking configuration, the braking pressure of at least one brake of said friction brakes is substantially equal to a first pressure value and the torque applied by the generator is equal to a first torque value,
wherein the vehicle braking system is configured to brake the vehicle according to a second braking configuration, wherein in the second braking configuration, the braking pressure of said at least one brake is substantially equal to a second pressure value different from the first pressure value, and the torque applied by the generator is equal to a second torque value,
wherein the vehicle braking system is configured to implement a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.

19. A vehicle, comprising:
an electric powertrain with a generator configured to apply a torque to at least one wheel of a plurality of wheels of the vehicle;
a pressure operated braking system comprising friction brakes each comprising a respective brake chamber, wherein each friction brake is configured for braking the vehicle as a function of a braking pressure in the brake chamber of the respective friction brake, wherein each braking pressure is controlled by at least one valve and according to an open-loop control;
a controller configured to receive a target value of a brake force, the brake force being a force resulting at least from the torque applied by the generator and the braking pressure in said brake chamber;
wherein in a first braking configuration of the vehicle, the braking pressure of at least one brake of said friction brakes is substantially equal to a first pressure value and the torque applied by the generator is equal to a first torque value,
wherein in a second braking configuration of the vehicle, the braking pressure of said at least one brake is substantially equal to a second pressure value different from the first pressure value, and the torque applied by the generator is equal to a second torque value,
wherein the controller is configured to implement a brake blending from the first braking configuration to the second braking configuration, wherein the brake blending comprises:
actuating the at least one valve a maximum number of times to change said braking pressure from the first pressure value to the second pressure value;
estimating a modification of said braking pressure over time to obtain a pressure modification estimation;
controlling the torque applied by the generator from the first torque value to the second torque value in function of said pressure modification estimation and in function of the target value of the brake force.
